(19) United States
(12) Patent Application Publication
(10) Pub. No.: US 2013/0227426 A1
(43) Pub. Date: Aug. 29, 2013

(54) CUSTOMIZED USER WEB-PAGE SETTING TECHNIQUES

(71) Applicant: Bibhudendu Mohapatra, San Diego, CA (US)

(72) Inventor: Bibhudendu Mohapatra, San Diego, CA (US)

(73) Assignee: SONY CORPORATION, Tokyo (JP)

(21) Appl. No.: 13/404,645

(22) Filed: Feb. 24, 2012

(51) Int. Cl. G06F 3/048

(52) U.S. Cl. 715/744

(57) ABSTRACT

Content configuration setting techniques, in accordance with embodiments of the present technology, include determining a given set of one or more configuration parameters associated with a given one of the items of content from a content configuration data structure. The one or more configuration parameters may include volume parameters, brightness parameters, contrast parameters, color parameters and/or the like. The given item of content is then output in a browser or a tab of the browser according to the given set of one or more configuration parameters.

### BACKGROUND OF THE INVENTION

Computing systems have made significant contributions toward the advancement of modern society and are utilized in a number of applications to achieve advantageous results. Numerous devices, such as desktop personal computers (PCs), laptop PCs, tablet PCs, netbooks, smart phones, servers, and the like have facilitated increased productivity and reduced costs in communicating and analyzing data in most areas of entertainment, education, business, and science.

One common aspect of computing devices is the use of browsers and similar applications to display content from a wide range of sources. However, content from such wide and various sources may have very different viewing parameters. For example, the audio portion of content from one source may be configured to output at volume substantially lower than content from another source. Similarly, content from yet another source may have a brightness setting that is different other content. The browser, however, is designed to enable a user to readily look at content from a large number of sources and quickly change from one source to another. When switching between the different sources of content, the changes in volume, brightness and the like can detract from the user's experience. Therefore, there is a continuing need for improved techniques for displaying content from various sources.

### SUMMARY OF THE INVENTION

The present technology may best be understood by referring to the following description and accompanying drawings that are used to illustrate embodiments of the present technology directed toward user customized content configuration setting techniques.

In one embodiment, a method begins with receiving one or more items of content. It is then determined if a content configuration data structure includes one or more configuration parameters associated with the given item of content. If the content configuration data structure does not already include one or more configuration parameters associated with the given item of content, an association of the unique identifier of the given item of content and one or more predetermined configuration parameters is added to the content configuration data structure. If the content configuration data structure includes one or more configuration parameters associated with the given item of content, it is determined if the given item of content has just been opened or has already been running in the browser or tab of the browser. If the given item of content has just been opened, the given item of content is output in the browser or the tab of the browser according to one or more predetermined configuration parameters associated with the unique identifier of the given item of content. Otherwise, if the given item of content has already been running in the browser or tab of the browser, the given item of content is output in the browser or the tab of the browser according to one or more current configuration parameters associated with the unique identifier of the given item of content.

In another embodiment, an electronic device includes a means for receiving one or more items of content. The electronic device also includes a means for determining from a data structure a given set of one or more configuration parameters associated with a given one of the items of content. The electronic device further includes a means for outputting the given item of content in a browser or a tab of the browser according to the given set of one or more configuration parameters

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of a computer, in accordance with one embodiment of the present technology.

FIG. 2 shows a block diagram of a television, in accordance with one embodiment of the present technology.

FIG. 3 shows a bock diagram of a generalized electronic device, in accordance with one embodiment of the present technology.

FIG. 4 shows a block diagram of an exemplary implementation of an electronic device, in accordance with one embodiment of the present technology.

FIG. 5 illustrates an exemplary content configuration data structure, in accordance with one embodiment of the present invention.

FIGS. 6A-6C shows a flow diagram of a method of accessing content, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signal's are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within die electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

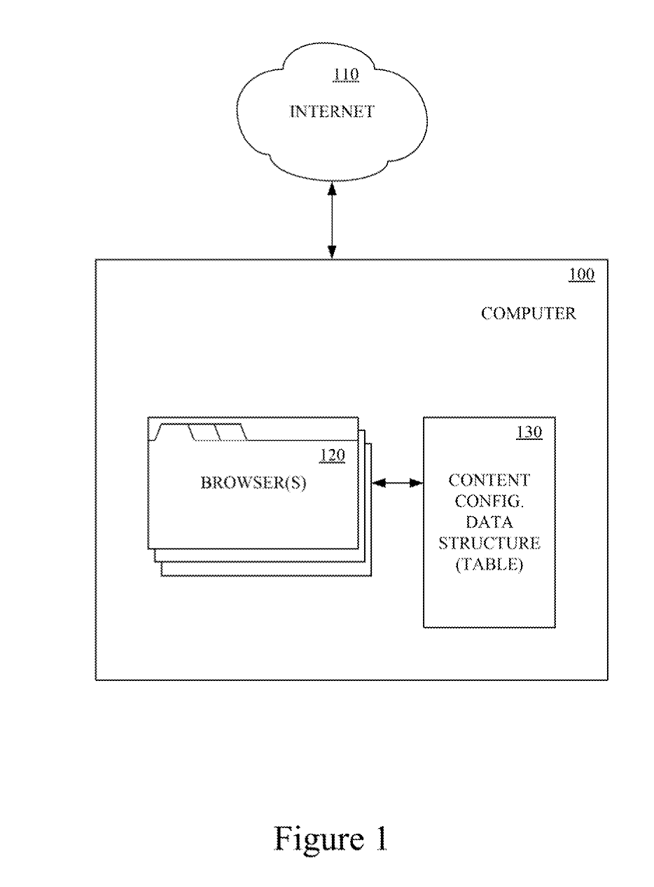

Embodiments of the present technology will first be described with reference to computer and television based implementations. Embodiments of the present technology will then be generalized and explained in further detail with regard to a general electronic device. Referring now to FIG. 1, a computer, in accordance with one embodiment of the present technology, is shown. The computer 100 is communicatively coupled to the internet 110. The computer implements one or more instance of a browser application, utility or the like for retrieving, presenting and traversing various sources of content on the display, speakers, and/or the like of the computer. Each instance of the browser may also implement multiple tabs for navigating and presenting different content source in each tab. The term browser 120 as used herein refers to any such application, utility or the like for retrieving, presenting and traversing various sources of content, and not just specifically web browsers.

The browser 120 provides a graphical user interface for navigating and viewing content from sources such as the internet, World Wide Web, or the like. The content may be retrieved, presented and traversed using corresponding uniform resource identifiers (URI) or the like. The browser 120 includes or is communicatively coupled to a content configuration data structure 130. The content configuration data structure 130 relates each of one or more items of content to a corresponding set of configuration parameters. The set of output parameters may include one or more of a volume, brightness, contrast, color and/or the like parameter values. The given content, displayed in an instance of a web browser and/or tab, is presented in accordance with the corresponding set of content parameter values in the browser configuration data structure 130.

In one implementation, the content configuration data structure 130 may be a table including a unique identifier, such as the uniform resource identifier, uniform resource locator (URL) or the like, for each item of content. For each item of content, a flag may indicate if the item of content was just opened up or if it has already been running. A current (e.g., adjusted) volume, brightness, contrast, color and/or the like parameter value may also be associated with the uniform resource locator. In addition, an average (e.g., default) volume, brightness, contrast, color and/or the like parameter value may also be associated with the uniform resource locator.

For the content in each instance of a browser or browser tab that becomes the current rendered browser or browser tab, the browser configuration table 130 is accessed to determine if the web page has just been opened or if it has already been running. If the page has just been opened, the content may be output on the display, speakers and/or the like using one or more average volume, brightness, contrast, color and/or the like parameter values. If the page has already been running, the content may be output using one or more current volume, brightness, contrast, color and/or the like parameter values associated in the table with the uniform resource locator of the content.

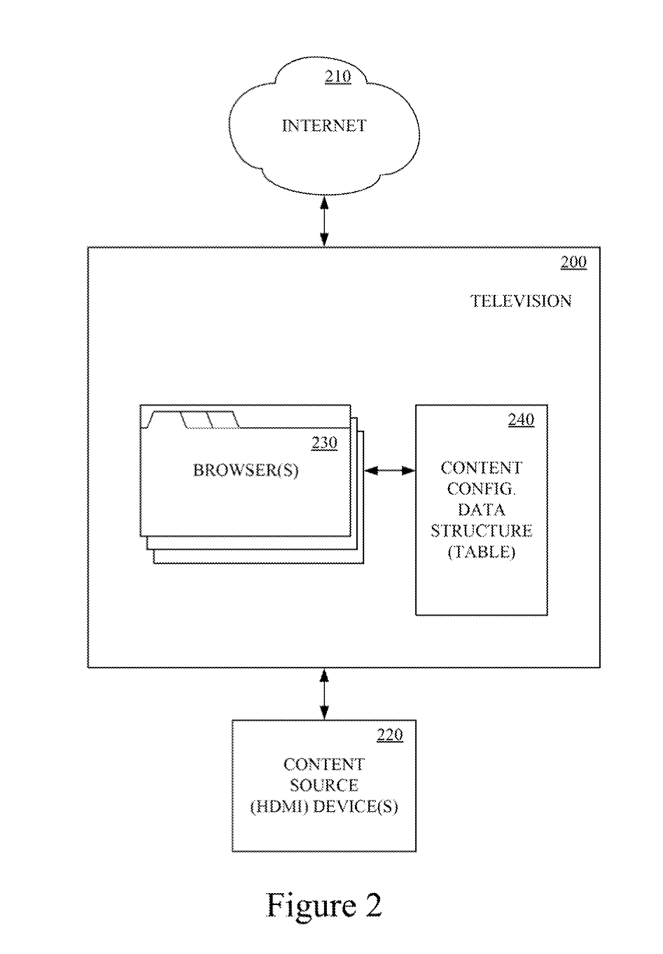

Referring now to FIG. 2, a television, in accordance with one embodiment of the present technology, is shown. The television 200 is communicatively coupled to the internet 210. The television 200 may also be communicatively coupled to one or more devices 220 that are sources of content, such as a Blu-ray player, a set top box, a satellite receiver, a digital video recorder (DVR), a game console, or the like. The television 200 implements one or more instance of a browser 230 for navigating and viewing content from sources such as the internet, the digital video recorder, and/or the like. Each instance of the browser 230 may implement multiple tabs for navigating and presenting different content in each tab. The content may be retrieved, presented and traversed using corresponding unique identifiers, such as a uniform resource identifier, uniform resource locator or the like.

The browser 230 includes or is communicatively coupled to a content configuration data structure 240. The content configuration data structure 240 relates each of one or more items of content to a corresponding set of configuration parameters. The set of configuration parameters may include one or more of a volume, brightness, contrast and/or the like parameter values. The given content, displayed in an instance of a web browser and/or tab, is presented in accordance with the corresponding set of content parameter values in the browser configuration data structure 240.

In one implementation, the content configuration data structure 240 may include a unique identifier, such as the uniform resource identifier (URI), uniform resource locator (URL), a content identifier and media access control (MAC) address pair, or the like, for each item of content. For each item of content, a flag may indicate if the item of content was just opened up or if it has already been running. A current volume, brightness, contrast, color and/or the like parameter value may also be associated with the uniform resource locator. In addition, an average volume, brightness, contrast, color and/or the like parameter value may also be associated with the uniform resource locator.

For the content in each instance of a browser or browser tab that becomes the current rendered browser or browser tab, the browser configuration table 240 is accessed to determine if the web page has just been opened or if it has already been running. If the page has just been opened, the content may be output on the display, speakers and/or the like using one or more average volume, brightness, contrast, color and/or the like parameter values. If the page has already been running, the content may be output using one or more current volume, brightness, contrast, color and/or the like parameter values associated in the table with the uniform resource locator of the content.

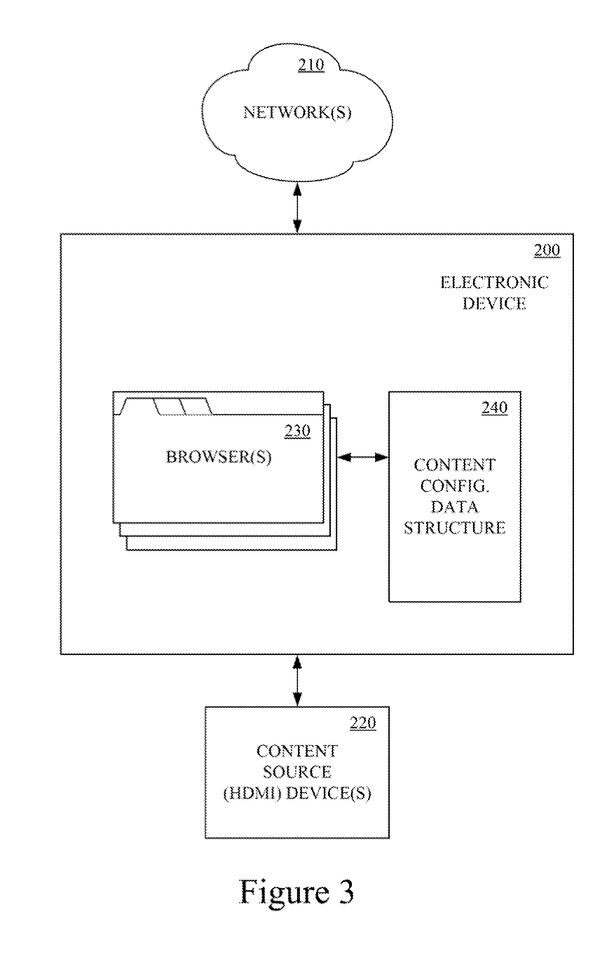

Referring now to FIG. 3, a generalized electronic device, in accordance with one embodiment of the present technology, is shown. The electronic device may be a desk top computer, laptop computer, television, cell-phone, smart phone, tablet, netbook, game console, and/or the like. The electronic device 300 is communicatively coupled to one or more networks 310, such as a local area network (LAN), wide area network (WAN), an intranet, the internet, the World Wide Web, and/or the like. The electronic device may also be communicatively coupled to one or more devices 320 that are source of content, such as Blu-ray player, a set top box, a satellite receiver, a digital video recorder (DVR), a game console, or the like and/or the like. The electronic device 300 may be communicatively coupled to the one or more networks and/or one or more content source devices by one or more wired and/or wireless communication links.

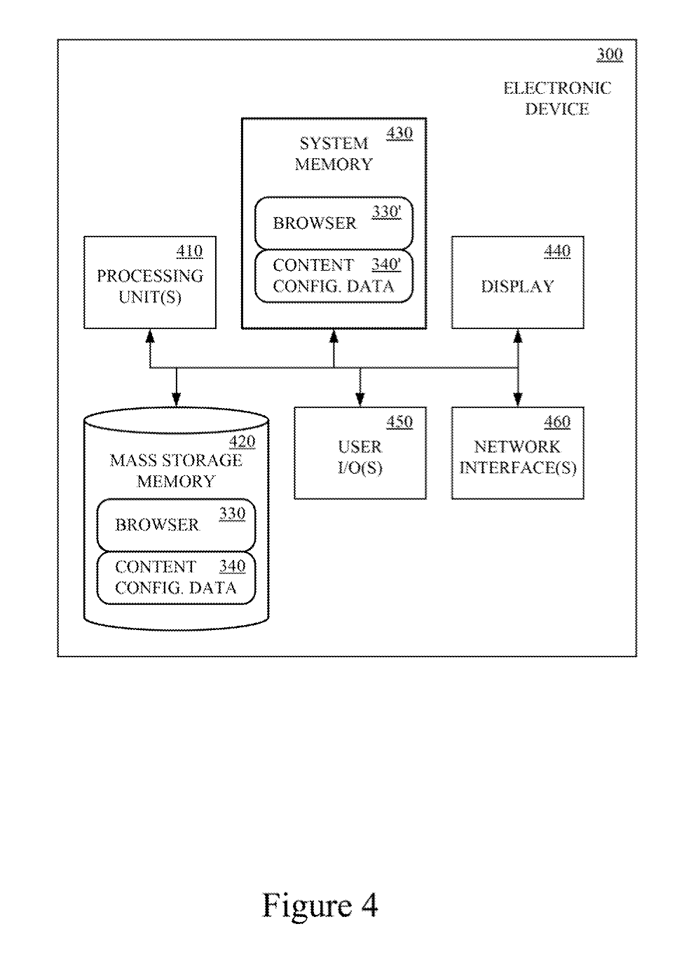

Operation of the electronic device 300 will be further explained with reference to FIGS. 4, 5 and 6A-6C. Referring to FIG. 4, an exemplary implementation of the electronic device 300, in accordance with one embodiment of the present technology, is shown. The electronic device 300 may include one or more processing units (e.g., microcontroller, embedded controller, central processing unit) 410, one or more memory units (e.g., read only memory (ROM), random access memory (RAM), hard disk, optical disk) 420, 430, a display 440, one or more user input/output (I/O) interfaces (e.g., keyboard, pointing device, remote control) 450, and one or more communication interfaces (e.g., modem, network interface card (NIC)) 460. The processing unit 410 executes one or more sets of computing device executable instructions (e.g. software) stored in the one or more memory units 420, 430 to implement one or more applications, tools, utilities, scripts, drivers, routines and/or the like and/or manipulate one or more data structures such as files, tables, databases, registries, libraries, and/or the like.

In particular, the processing unit 410 executes the one or more set of computing device executable instructions to implement one or more instance of a browser 330, 330′ for retrieving, presenting and traversing various sources of content on the display, speakers, and/or the like of the electronic device 300. The browser 330, 330′ provides a graphical user interface for navigating and viewing content from sources such as a digital video recorder, the internet, World Wide Web, or the like. Each instance of the browser may implement multiple tabs for navigating and presenting a different content source in the graphical user interface of each tab. The content is retrieved, presented and traversed using corresponding unique identifiers, such as a uniform resource identifier, uniform resource locator, or the like.

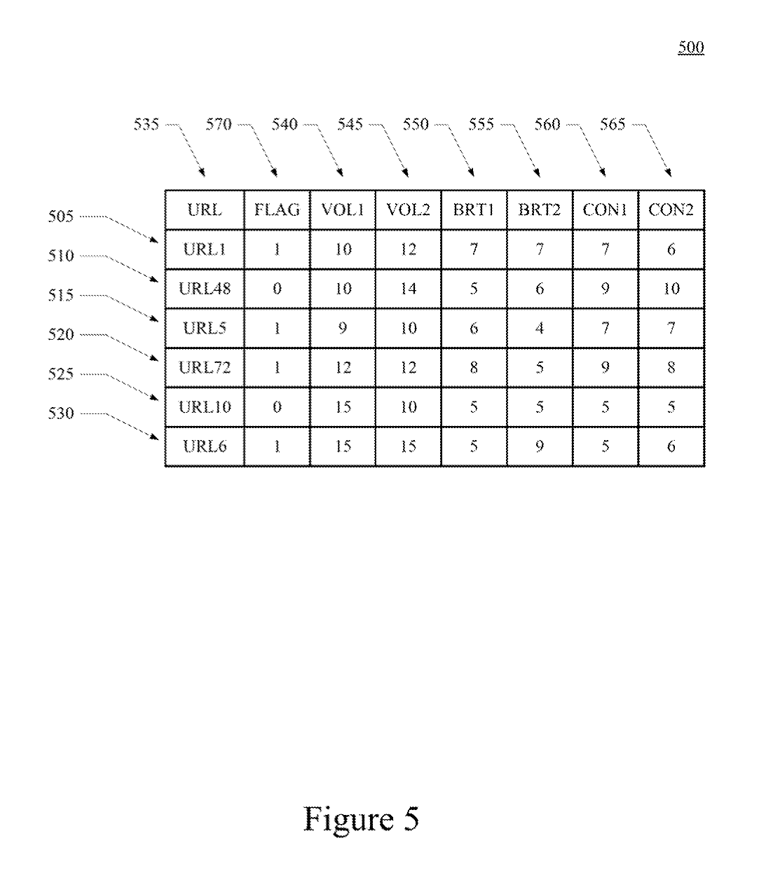

The browser 330, 330′ includes or is communicatively coupled to a content configuration data structure 340, 340′. The content configuration data structure 340, 340′ relates each of one or more items of content to a corresponding set of configuration parameters. The set of configuration parameters may include one or more of a volume, brightness, contrast, color and/or the like parameter values. Referring now to FIG. 5, an exemplary content configuration data structure, in accordance with one embodiment of the present invention. The exemplary content configuration data structure 500 may include a plurality of records 505-530. Each record 505-535 maps an identifier 535 that uniquely identifies a given instance of content to a corresponding set of one or more configuration parameters 540-565. The identifier 535 may be a uniform resource identifier (URI), a uniform resource locator (URL), a content identifier and media access control (MAC) address pair, or the like of a given instance of content. The set of one or more configuration parameters 540-565 may include one or more predetermined volume, brightness, contrast, color and/or the like parameter values 540, 550, 560. The predetermined values may be default values, initial value or an average value for one or more of the parameter. The set of one or more configuration parameters 540-565 may also include one or more current or adjusted volume, brightness, contrast, color and/or the like parameter values 545, 555, 565. In addition, each record may include a flag 570 indicating if the given instance of content has just been opened or if it has already been running in the browser or browser tab. It is appreciated that the values in the table are for illustrative purposes only and are not intended to show actual values.

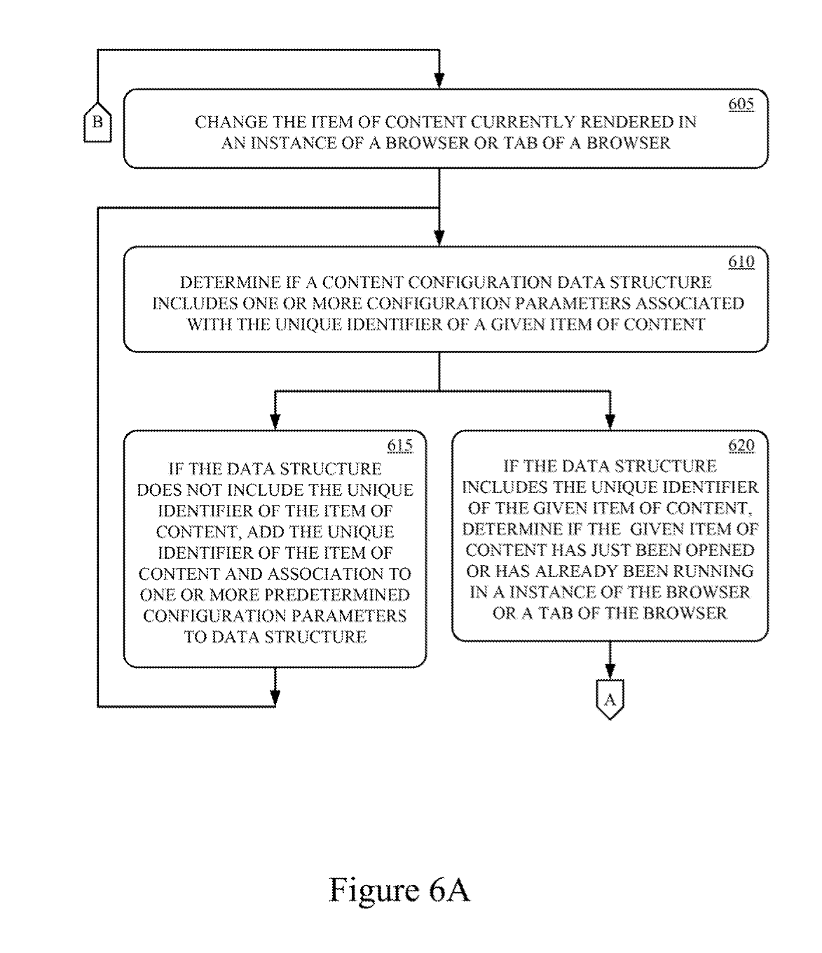

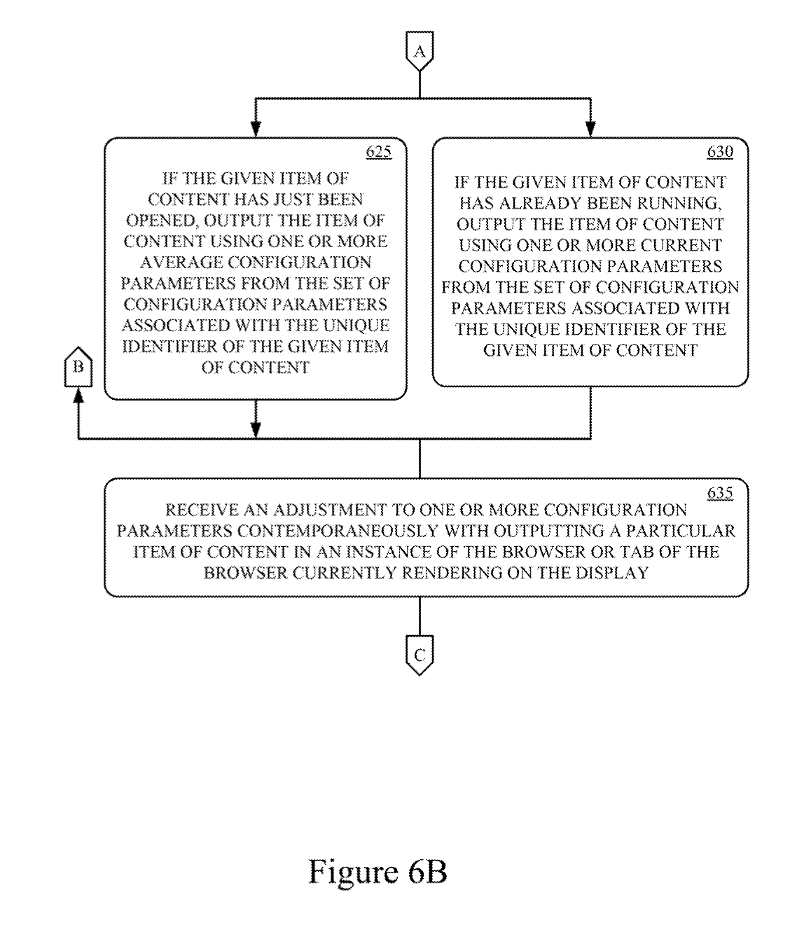

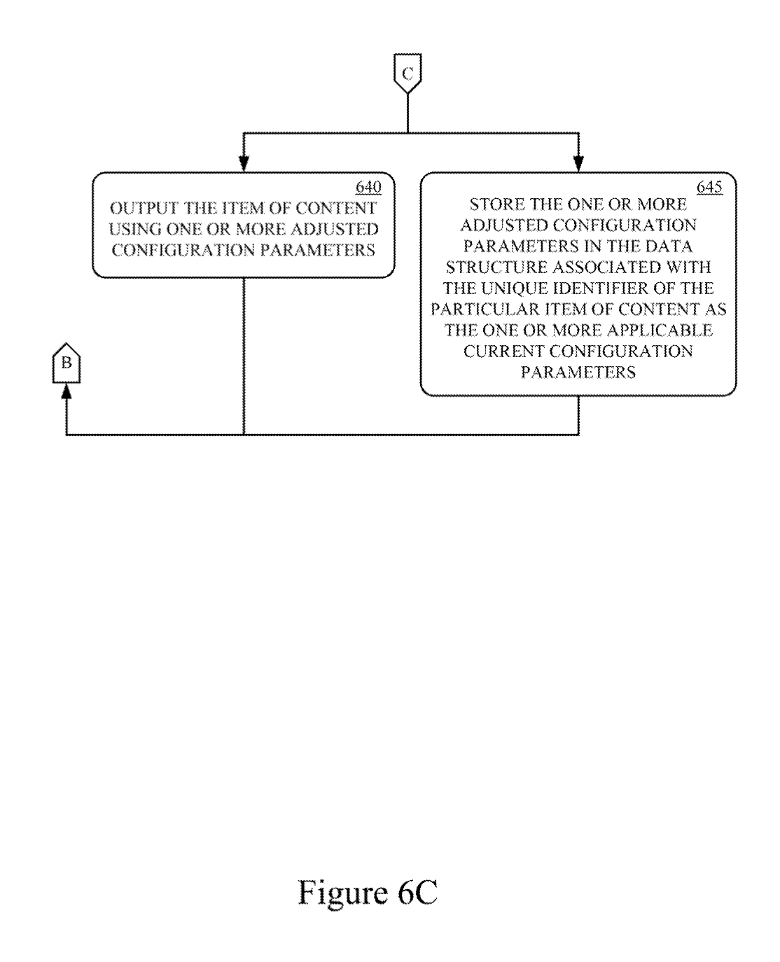

Referring now to FIGS. 6A-6C, a method of accessing content, in accordance with one embodiment of the present technology, is shown. The method may be implemented as computing device-executable instructions (e.g., computer program) that are stored in computing device-readable media (e.g., computer memory) and executed by a computing device (e.g., processor). The method begins with a change in the currently rendered browser or browser tab content, at 605. The change may comprise rendering a new item of content in a particular instance of a browser or browser tab. The change may also comprise switching from rendering one item of content in one instance of a browser to rendering a different item content in another instance of the browser while the first item is pushed into the background. Likewise, the change may also comprise switching from rendering one item of content in one browser tab to rendering a different item content in another browser tab. In one implementation, a routine (e.g., a set of computing device executable instructions) executed on the processing unit tracks the instance of the browser or tab of the browser that is currently being rendered on the display unit.

At 610, it is determined if a content configuration data structure includes a set of one or more configuration parameters associated with a unique identifier of the given item of content to be rendered in the current browser or browser tab. In one implementation, a routine executed by the processing unit may compare the unique identifier received of the item of content to unique identifiers in the records of the content configuration data structure. The unique identifier may be a uniform resource identifier (URI), a uniform resource locator (URL), a content identifier and media access control (MAC) address pair, or the like.

If the data structure does not include the unique identifier of the given item of content, the unique identifier and an associated set of one or more predetermined configuration parameters are added to the content configuration data structure, at 615. In one implementation, a routine executed by the processing unit may create a new record including an association between the unique identifier of the item of content and a set of one or more predetermined configuration parameters. In one implementation, the set of one or more predetermined configuration parameters may be default settings for each of one or more of volume, brightness, contrast, color and/or the like parameters. In another implementation, the set of one or more predetermined configuration parameters may be initial values for each of one or more of volume, brightness, contrast, color and/or the like parameters. In one implementation, the default, initial or the like parameter values may be saved as both current volume, brightness, contrast, color and/or the like values and average volume, brightness, contrast, color and/or the like values. The processing unit may also set a flag in the record to indicate that the given item of content has just been opened. After adding the association between the unique identifier and one or more predetermined configuration parameters to the data structure, the process may continue at 610. Alternatively, the process may continue at 625 or 640.

If the data structure includes the unique identifier of the given item of content, it is determined if the given item of content has just been opened or has already been running in an instance of the browser or a tab of the browser, at 620. In one implementation, the processing unit checks the state of the flag in the record having a unique identifier matching the unique identifier received with the item of content to determine if the given item of content has just been opened or has already been running. If the flag is in a first state (e.g., 0), the item of content was just opened. If the flag is in a second state (e.g., 1), the item of content has already been running in an instance of the browser or a tab of the browser.

At 625, the item of content is output in a given instance of a browser of a given tab of the browser using one or more predetermined configuration parameters, if the given item of content has just been opened. In one implementation, the given item of content is output using one or more default configuration parameters associated with the unique identifier of the given item of content in the content configuration data structure. In another implementation, the given item of content is output using one or more average configuration parameters associated with the unique identifier of the given item of content in the content configuration data structure. For example, the one or more predetermined configuration parameters may specify an average volume level, brightness level, contrast level and/or the like that is applied to the given item of content for output in the given instance of the browser or given tab of the browser.

At 630, the item of content is output in a given instance of a browser of a given tab of the browser using one or more current configuration parameters, if the given item of content has already been running in the browser. In one implementation, the given item of content is output using one or more configuration parameters that were adjusted by the user and are associated with the unique identifier of the given item of content in the content configuration data structure. For example, the one or more predetermined configuration parameters may specify a volume level, brightness level, contrast level and/or the like parameter value adjusted by the user.

The processes of 605-630 may be repeated for each additional received item of content for output in an instance of the browser or tab of the browser. For example, the user may switch to a different instance of the browser of a different tab of the browser outputting a different item of content. Alternatively, the user may navigate to a different item of content using the same instance of the browser or the same tab. In one implementation, a utility tracks the specific instance of the browser or tab of the browser that is currently being rendered on the display. When the specific instance of the browser or tab of the browser changes the utility causes the processed of 605-635 to be executed again.

In addition, an adjustment to one or more configuration parameters may be received contemporaneously with outputting a particular item of content in an instance of the browser or tab of the browser, at 635. At 640, the particular item of content is output using the one or more adjusted configuration parameters. At 650, the one or more adjusted configuration parameters are stored in the data structure associated with the unique identifier of the particular instance of content as the current configuration parameters. In addition, the average of each of one or more configuration parameters may be updated based upon the adjustments made to one or more configuration parameters. Again, the processes of 605-630 may be repeated thereafter for each additional received item of content for output in an instance of the browser or tab of the browser.

Embodiments of the present technology advantageously provide techniques for setting output parameters for web-pages and other content. Embodiments advantageously enable user customized web-page settings.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

1. A method comprising:
receiving, by a processing unit, one or more items of content;
determining, by the processing unit from a data structure, a given set of one or more configuration parameters previously associated by a user of the processing unit with a given one of the items of content, wherein the one or more configuration parameters are selected from a group consisting of a volume parameter, a brightness parameter, a contrast parameter, and a color parameter; and
outputting, by the processing unit, the given item of content in a browser or a tab of the browser according to the given set of one or more configuration parameters.

2. The method according to claim 1, wherein determining the given set of one or more configuration parameters comprises matching a unique identifier of the given item of content received with the given item of content to the unique identifier in the data structure that is associated with the given set of one or more configuration parameters.

3. The method according to claim 1, wherein determining the given set of one or more configuration parameters comprises:
determining if a content configuration data structure includes one or more configuration parameters associated with the given item of content;
adding an association of a unique identifier of the given item of content and one or more predetermined configuration parameters to the content configuration data structure, if the content configuration data structure does not already include one or more configuration parameters associated with the given item of content; and
determining if the given item of content has just been opened or has already been running in the browser or tab of the browser, if the content configuration data structure includes one or more configuration parameters associated with the given item of content.

4. The method according to claim 3, wherein outputting the given item of content in the browser or the tab of the browser according to the given set of one or more configuration parameters comprises:
outputting the given item of content in the browser or the tab of the browser according to one or more predetermined configuration parameters associated with a unique identifier of the given item of content, if the given item of content has just been opened; and
outputting the given item of content in the browser or the tab of the browser according to one or more current configuration parameters associated with the unique identifier of the given item of content, if the given item of content has already been running in the browser or tab of the browser.

5. The method according to claim 1, further comprising:
determining, by a processing unit, another set of one or more predetermined configuration parameters used to output another one of the items of content; and
outputting, by the processing unit, the other item of content in another instance of the browser or another tab of the browser according to the other set of one or more predetermined configuration parameters.

6. The method according to claim 5, further comprising:
receiving an adjusted one or more configuration parameters for outputting the other item of content in the other instance of the browser or other tab of the browser; and
storing an association of the adjusted one or more configuration parameters with a unique identifier of the given item of content in the data structure.

7. The method according to claim 1, wherein the given set of one or more configuration parameters comprises one or more predetermined configuration parameters values.

8. The method according to claim 1, wherein the given set of one or more configuration parameters comprises one or more currently adjusted configuration parameters values.

9. A method comprising:
receiving, by a processing unit, one or more items of content;
determining, by the processing unit, if a content configuration data structure includes one or more configuration parameters associated with the given item of content having a unique identifier, the configuration parameters being prior user-established parameters not being derived from user navigation of a web page;
adding, by the processing unit, an association of the unique identifier of the given item of content and one or more predetermined configuration parameters to the content configuration data structure, if the content configuration data structure does not already include one or more configuration parameters associated with the given item of content;
determining, by the processing unit, if the given item of content has just been opened or has already been running in the browser or tab of the browser, if the content configuration data structure includes one or more configuration parameters associated with the given item of content;
outputting, by the processing unit, the given item of content in the browser or the tab of the browser according to one or more predetermined configuration parameters associated with the unique identifier of the given item of content, if the given item of content has just been opened; and
outputting, by the processing unit, the given item of content in the browser or the tab of the browser according to one or more current configuration parameters associated with the unique identifier of the given item of content, if the given item of content has already been running in the browser or tab of the browser.

10. The method according to claim 9, wherein the one or more predetermined configuration parameters comprise initial, default or average configuration parameters values.

11. The method according to claim 9, wherein the one or more current configuration parameters comprise adjusted configuration parameters values.

12. The method according to claim 9, wherein determining if a content configuration data structure includes one or more configuration parameters associated with the given item of content comprises matching the unique identifier of the given item of content received with the given item of content to one of a plurality of unique identifier in the data structure.

13. An electronic device comprising:
a computer readable storage medium bearing instructions executable by a processor;
a configured for accessing and executing the instructions for:
receiving one or more items of content;
determining from a data structure a given set of one or more configuration parameters previously associated by a user of the electronic device with a given one of the items of content having a unique identifier, wherein the one or more configuration parameters are selected from a group consisting of a volume parameter, a brightness parameter, a contrast parameter, and a color parameter; and
outputting the given item of content in a browser or a tab of the browser according to the given set of one or more configuration parameters.

14. The electronic device of claim 13, wherein the processor executes the instructions for matching the unique identifier of the given item of content received with the given item of content to one or a plurality of unique identifiers in the data structure.

15. The electronic device of claim 13, wherein:
the processor executes the instructions for:
determining if a content configuration data structure includes one or more configuration parameters associated with the given item of content;
adding an association of the unique identifier of the given item of content and one or more predetermined configuration parameters to the content configuration data structure, if the content configuration data structure does not already include one or more configuration parameters associated with the given item of content; and
determining if the given item of content has just been opened or has already been running in the browser or tab of the browser, if the content configuration data structure includes one or more configuration parameters associated with the given item of content.

16. The electronic device claim 15, wherein the processor executes the instructions for:
outputting the given item of content in the browser or the tab of the browser according to one or more predetermined configuration parameters associated with the unique identifier of the given item of content, if the given item of content has just been opened; and
outputting the given item of content in the browser or the tab of the browser according to one or more current configuration parameters associated with the unique identifier of the given item of content, if the given item of content has already been running in the browser or tab of the browser.

17. The electronic device of claim 13, wherein the processor executes the instructions for:
determining another set of one or more predetermined configuration parameters used to output another one of the items of content; and
outputting the other item of content in another instance of the browser or another tab of the browser according to the other set of one or more predetermined configuration parameters.

18. The electronic device of claim 17, wherein the processor executes the instructions for:
receiving an adjusted one or more configuration parameters for outputting the other item of content in the other instance of the browser or other tab of the browser; and
storing an association of the adjusted one or more configuration parameters with the unique identifier of the given item of content in the data structure.

19. The electronic device of claim 13, wherein the given set of one or more configuration parameters comprises one or more predetermined configuration parameters values.

20. The electronic device of claim 13, wherein the given set of one or more configuration parameters comprises one or more currently adjusted configuration parameters values.
